(19) United States
(12) Patent Application Publication
(10) Pub. No.: US 2024/0085911 A1
(43) Pub. Date: Mar. 14, 2024

(54) PLANNING A PATH OF A DRIVERLESS MOBILE ROBOT

(71) Applicant: KUKA Deutschland GmbH, Augsburg (DE)

(72) Inventors: Dominik Joho, Augsburg (DE); Andreas Kuhner, Augsburg (DE)

(73) Assignee: KUKA Deutschland GmbH, Augsburg (DE)

(21) Appl. No.: 18/262,055

(22) PCT Filed: Jan. 12, 2022
(86) PCT No.: PCT/EP2022/050501

§ 371 Date: Jul. 19, 2023

(30) Foreign Application Priority Data
Jan. 22, 2021 (DE) 10 2021 200 600.0

(51) Int. Cl. G05D 1/02

(52) U.S. Cl. CPC G05D 1/0212

(57) ABSTRACT

A method for planning a path of a driverless mobile robot for approaching a second pose specified in a second reference system, from a first pose specified in a first reference system, includes transforming one of the first or second poses into a common reference system, in which the other of the first and second pose is also described, and planning a transition path from the first pose to the second pose in the common reference system on the basis of the first and second pose described in the common reference system.

### CROSS-REFERENCE TO RELATED APPLICATIONS

This application is a national phase application under 35 U.S.C. § 371 of International Patent Application No. PCT/EP2022/050501, filed Jan. 12, 2022 (pending), which claims the benefit of priority to German Patent Application No. DE 10 2021 200 600.0, filed Jan. 22, 2021, the disclosures of which are incorporated by reference herein in their entirety.

### TECHNICAL FIELD

The present invention relates to a method for planning, in particular setting off on, a path of a driverless mobile robot, and to a system and computer program product for carrying out the method.

### BACKGROUND

Driverless mobile robots are often intended to approach or set off from poses or path (segment)s, which are specified in various reference systems.

One example is an environment-related reference system or a map of the environment (“environment map”) in which the robot is to navigate and approach an object. If said robot is sufficiently close to the object, a switch is made to an object-related reference system and in said system further navigation is performed and the object is approached.

In this case, hitherto a path is first planned in the environment-related reference system, and then in the object-related reference system. In this case, a disadvantage is that the robot must stop when a change is made from one to the other path or from one to the other reference system.

Another example is a plurality of environment-related reference systems or environment maps into which an overall environment is divided, for example for reasons of storage space. Here too, hitherto it is not possible to plan a continuous path via two or more reference systems.

### SUMMARY

An object of an embodiment of the present invention is to improve the operation of a driverless mobile robot, in particular its path planning.

This object is achieved by a method, and a system and computer program product for carrying out a method as described herein.

According to one embodiment of the present invention, a method for planning a path of a driverless mobile robot for approaching a second pose specified in a second reference system, from a first pose specified in a first reference system, comprises the step, in one embodiment repeated one or more times, of:
transforming the second pose into a common reference system in which the first pose is also described or indicated; and/or
transforming the first pose into a or the common reference system in which the second pose is described or indicated.

In one embodiment, the mobile robot has a mobile base or platform, in a development a preferably steerable chassis. In one embodiment, the driverless mobile robot is what is known as an AGV (Automated Guided Vehicle). The present invention is particularly suitable for this purpose due to the conditions of use of AGVs.

In one embodiment, a pose in the sense of the present invention comprises a, in particular one-, two- or three-dimensional, position and/or an, in particular one-, two- or three-dimensional, orientation, particularly preferably a two-dimensional position and one-dimensional orientation. In one embodiment, a pose in the sense of the present invention comprises a, in particular one-, three- or particularly preferably two-dimensional, position and/or an, in particular two-, three- or particularly preferably one-dimensional, orientation, a or the mobile base or platform, in one embodiment a or the chassis of the mobile robot. In one embodiment, the first pose is a pose of the mobile robot, in a development it is a pose of a or the mobile base or platform, in one embodiment of a or the chassis of the mobile robot, and/or the second pose is a pose of the mobile robot, in a development it is a pose of a or the mobile base or platform, in one embodiment of a or the chassis of the mobile robot. In one embodiment, the transition path transfers the mobile robot, in a development a or the mobile base or platform, in one embodiment a or the chassis of the mobile robot, from the first into the second pose.

The common reference system can in particular be the first reference system. Then, in one embodiment, the second pose is transformed into the common (=first) reference system in which the first pose is specified.

In this way, in one embodiment, particularly efficient path planning can be realized.

In another embodiment, the common reference system is the second reference system. Then, in one embodiment, the first pose is transformed into the common (=second) reference system in which the second pose is specified.

In this way, in one embodiment, particularly precise path planning can be realized.

Likewise, the common reference system can be a reference system different from the first and second reference systems. Then, in one embodiment, the first and second pose are transformed into this common reference system, so that they are described therein.

In this way, in one embodiment, particularly variable path planning can be realized.

According to one embodiment of the present invention, the method comprises the step, in one embodiment repeated one or more times, of:
planning a transition path from the first pose to the second pose in the common reference system on the basis of the first and second pose described in this common reference system.

By transforming one of the first and second pose into the other reference system, in which the other of the first and second pose is specified, or by transforming the first and second pose into a common reference system, and thus the first and second pose being described in the common reference system, in one embodiment a transition path can advantageously be planned, and set off on in a development, in one embodiment without stopping the robot during a change from one to the other reference system.

In one embodiment, the first pose is specified on a first path segment, in a development by a first path segment, in the first reference system, or, optionally, only the first path segment (and thereby implicitly a or the first pose) is specified in the first reference system, and the transition path is planned on the basis of the first pose described in the common reference system, in that it is planned on the basis of the first path segment (and thus implicitly on the basis of a or the first pose) described in the common reference system, in one embodiment transformed into this.

Additionally or alternatively, in one embodiment, the second pose is specified on a second path segment, in a development by a second path segment, in the second reference system, or, optionally, only the second path segment (and thereby implicitly a or the second pose) is specified in the second reference system, and the transition path is planned on the basis of the second pose described in the common reference system, in that it is planned on the basis of the second path segment (and thus implicitly on the basis of a or the second pose) described in the common reference system, in one embodiment transformed into this.

Accordingly, a path or the planning of a path of the driverless mobile robot for approaching a second pose, which is specified in a second reference system, from a first pose, which is specified in a first reference system, can comprise, in particular be, a path or the planning of a path for setting off, at least in part, on the first path segment (and thus from a (possibly only implicitly specified) first pose on the first path segment) and, in particular, subsequent, at least partial tracing of the second path segment on the second path segment), from a first pose, which is predetermined in a first reference system, and in particular subsequently, setting off, at least in part, on the second path segment (and thus approaching a (possibly only implicitly specified) second pose on the second path segment). A transition path or a planning of a transition path from the first pose to the second pose in the common reference system, on the basis of the first and second pose described in this common reference system, can accordingly comprise, in particular be, a transition path or planning of a transition path from the first path segment (and thus from a (possibly only implicitly specified) first pose on the first path segment) to the second path segment (and thus into a (possibly only implicitly specified) second pose on the second path segment) on the basis of the first and second path segments described in this common reference system (and thus the first and second pose described (possibly only implicitly) in the common reference system).

In one embodiment, the second pose is transformed into the common reference system by transforming the second path segment into the common reference system. Additionally or alternatively, in one embodiment, the first pose is transformed into the common reference system by transforming the first path segment into the common reference system.

By using path segments, it is possible in one embodiment to improve the planning and/or operation, in particular to increase its efficiency and/or precision. In one embodiment, the first path segment and/or the second path segment is a straight path segment. In one embodiment, the planning and/or operation can thereby be further improved, in particular its efficiency and/or precision can be further increased.

In one embodiment, the transition path transfers (the robot) continuously, in one embodiment (on a) continuously differentiable (path), from the first to the second path segment, it being able to deviate from the first path segment before a path end of said first path segment and being able to set down on the second path segment after a path start or before a path of said second path segment.

In one embodiment, the operation of the robot can be improved thereby, in particular a load and/or cycle time can be reduced.

In one embodiment, in at least one, in particular initial, passage through or at least one of the steps of the method, the transformation of one of the first and second path segments into the common reference system is determined on the basis of a specified relation, in one embodiment of an identity, of a pose, in one embodiment of an end pose, on the first path segment, with a pose, in one embodiment an initial pose, relative to, in one embodiment on, the second path segment.

By determining, in particular in a first passage of transformation of one of the first and second path segments and planning of a transition path, the (this) transformation on the basis of the specified relation, in particular with the proviso that the end pose on the first path segment should be the same as the initial pose on the second path segment, in one embodiment the transition path can advantageously also be planned, in particular initially, without initializing or calibrating the second reference system.

A pose which is used in an initialization, in particular calibration, of the second reference system is expediently an initial pose on the second path segment. However, a different pose relative to the second path segment can also be used, in particular a pose which is used in an initialization, in particular calibration, of the second reference system. Accordingly, in one embodiment, the transformation is determined with the proviso that the end pose on the first path segment should be the same as the pose used during an initialization, in particular calibration, of the second reference system.

Additionally or alternatively, in one embodiment, in at least one, in particular further or subsequent passage through or at least one of the steps of the method, the transformation of one of the first and second pose, in particular of one of the first and second path segments, into the common reference system is determined on the basis of a specified relation, in particular identity, of a pose, in particular actual pose, of the robot, which is described in the reference system in which said one of the first and second pose or said one of the first and second path segments is specified, with a pose, in particular actual pose, of the robot, which is described in the common reference system.

By determining, in particular in one or more subsequent passages of transformation and planning of a transition path, the transformation (in each case) on the basis of the specified relation, in particular with the proviso that the actual pose of the robot which is described in the reference system from which the transformation takes place, should be the same as the actual pose of the robot in the common reference system, in one embodiment the precision can advantageously be increased, in particular the transformation and/or transition path can be updated.

As explained above, the transformation can be determined, instead of on the basis of the actual poses, in particular also on the basis of an end pose on the first path segment and a pose which is used during an initialization, in particular calibration, of the second reference system.

Additionally or alternatively, in one embodiment, in at least one, in particular further or subsequent, passage through or at least one of the steps of the method, the transformation of one of the first and second pose, in particular of one of the first and second path segments, into the common reference system is determined on the basis of a specified relation, in particular identity, of a pose, in particular actual pose, of the robot, which is described in the reference system in which said one of the first and second pose or said one of the first and second path segments is specified, with a pose, in particular actual pose, of the robot, which is described in the common reference system.

In one embodiment, the first reference system is an environment-related reference system, in which or by means of which the robot navigated, at least intermittently, in a development. In one embodiment, the robot is located at least intermittently in the first, in particular environment-related, reference system. In one embodiment, the first reference system is calibrated relative to an environment, in particular a plurality of orientation points, for example by means of SLAM or the like.

Additionally or alternatively, in one embodiment, the second reference system is an object-related reference system which, in a development, is specified, in particular calibrated, in particular is calibrated, relative to an object which the robot is to approach in one embodiment. In one embodiment, the robot is located at least intermittently in the second, in particular object-related, reference system.

In an alternative embodiment, the second reference system is a different environment-related reference system, in particular adjoining the first reference system or overlapping therewith at least in part, the robot, in a development, being at least intermittently navigated in or by means of the second reference system. In one embodiment, the robot is located at least intermittently in this second reference system, which is in particular also environment-related.

In one embodiment, the robot navigates, in particular in a first phase, with the aid of the second reference system, and, in particular in a second phase, with the aid of the second reference system, in one embodiment changes from the first to the second reference system, in a development without stopping. In one embodiment, in the second phase it approaches the second pose specified in the second reference system or sets off on the second path segment specified in the second reference system, at least in part, it preferably using the pose or path segment specified in the second reference system, in particular directly or in the second reference system. Additionally or alternatively, in one embodiment, the robot sets off, at least in part, on the first path segment specified in the first reference system in the first phase, it preferably using the path segment specified in the first reference system, in particular directly or in the first reference system.

A reference system within the meaning of the present invention comprises, in one embodiment, a map, in particular can be such a map.

In one embodiment, the system, in particular the robot, has a first localizer which determines the pose of the robot relative to or in the first reference system, in one embodiment updates it multiple times, in a development already before and/or during the planning of and/or setting off on the path. Additionally or alternatively, in one embodiment, the system, in particular the robot, has a second localizer which determines the pose of the robot relative to or in the second reference system, in one embodiment updates it multiple times, in a development not until during the planning of and/or setting off on the path. Accordingly, in one embodiment, the first reference system is a reference system in or relative to which the first localizer or a first localizer determines the pose of the robot, in particular relative to an environment, in one embodiment updates it multiple times, in a development already before and/or during the planning of and/or setting off on the path, and/or the second reference system is a reference system in or relative to which the or a second localizer determines the pose of the robot, in particular relative to an object, in one embodiment updates it multiple times, in a development only during the planning of and/or setting off on the path.

According to one embodiment of the present invention, a method for operating the robot comprises the steps, in one embodiment repeated one or more times, of:
planning a path according to a method described herein; and setting off on the path using the robot, in one embodiment with the aid of the first reference system, the second reference system and/or the common reference system, in a development with switching from the first to the second reference system.

In one embodiment, the transition path, in a development the transformation into the common reference system, is updated one or more times during the setting off.

As a result, in one embodiment the robots can advantageously be moved on the basis of poses or path segments specified in two reference systems, preferably without stopping during a change.

According to one embodiment of the present invention, a system, in particular in terms of hardware and/or software, in particular in terms of programming, is configured to perform a method described herein and/or comprises:
means for, in particular multiple, transformation of one of the first and second pose into a common reference system in which the other of the first and second pose is also described; and means for, in particular multiple, planning of a transition path from the first pose into the second pose in this common reference system on the basis of the first and second pose described in said common reference system.

In one embodiment, the system or the means thereof has:
means for setting off on the path using the robot, in particular with the aid of the first, second and/or common reference system; and/or
means for planning the transition path on the basis of the first pose described in the common reference system, in that the transition path is planned on the basis of the first path segment described in the common reference system, in particular transformed into this; and/or
means for planning the transition path on the basis of the second pose described in the common reference system, in that the transition path is planned on the basis of the second path segment described in the common reference system, in particular transformed into this; and/or
means for transforming the first pose into the common reference system by transforming the first path segment into the common reference system, and/or for transforming the second pose into the common reference system by transforming the second path segment into the common reference system; and/or
means for determining the transformation of one of the first and second path segments into the common reference system on the basis of a specified relation, in particular identity, of a pose, in particular end pose, on the first path segment with a pose, in particular initial pose, relative to, in particular on, the second path segment; and/or
means for determining the transformation of one of the first and second pose, in particular of one of the first and second path segments, into the common reference system on the basis of a specified relation, in particular identity, of a pose, in particular actual pose, of the robot, which is described in the reference system, in which said one of the first and second pose or said one of the first and second path segments is specified, with a pose, in particular actual pose, of the robot, which is described in the common reference system; and/or
means for updating the transition path and/or transformation into the common reference system during the setting off.

A means within the meaning of the present invention may be designed in hardware and/or in software, and in particular may comprise a data-connected or signal-connected, in particular, digital, processing unit, in particular microprocessor unit (CPU), graphic card (CPU) having a memory and/or bus system or the like and/or one or a plurality of programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to plan the path or operate, in particular control, the robot. In one embodiment, a computer program product may comprise—and may in particular be—an in particular non-volatile storage medium for storing a program, or having a program stored thereon, an execution of this program causing a system or a controller, in particular a computer, to carry out the method described herein, or one or more steps thereof.

In one embodiment, one or more, in particular all, steps of the method are performed completely or partially automatically, in particular by the system or its means.

In one embodiment, the system comprises the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a driverless mobile robot and a first reference system when planning a path of the robot according to one embodiment of the present invention;

FIG. 2 shows a second reference system when planning the path;

FIG. 3 shows an initially planned transition path;

FIG. 4 shows the first reference system during further planning of the path during setting off on the path using the robot;

FIG. 5 shows the second reference system during further planning of the path during setting off on the path using the robot;

FIG. 6 shows a transition path updated during setting off; and

FIG. 7 shows a method for planning the path according to an embodiment of the present invention.

### DETAILED DESCRIPTION

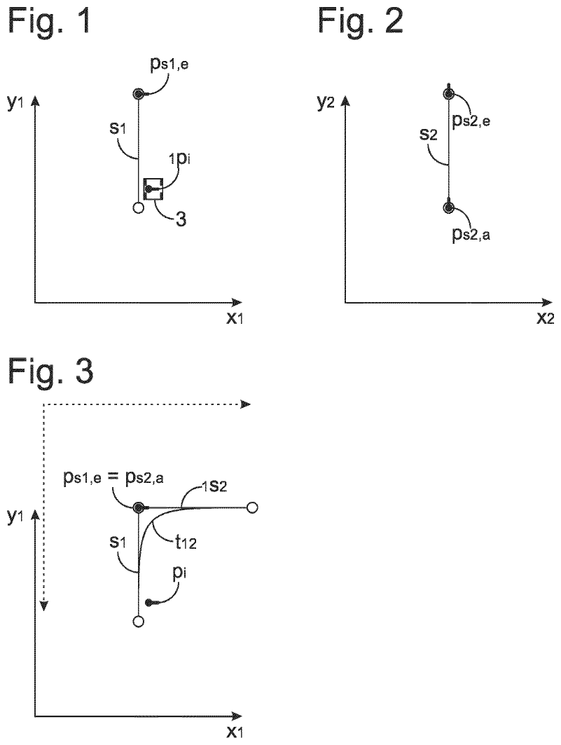

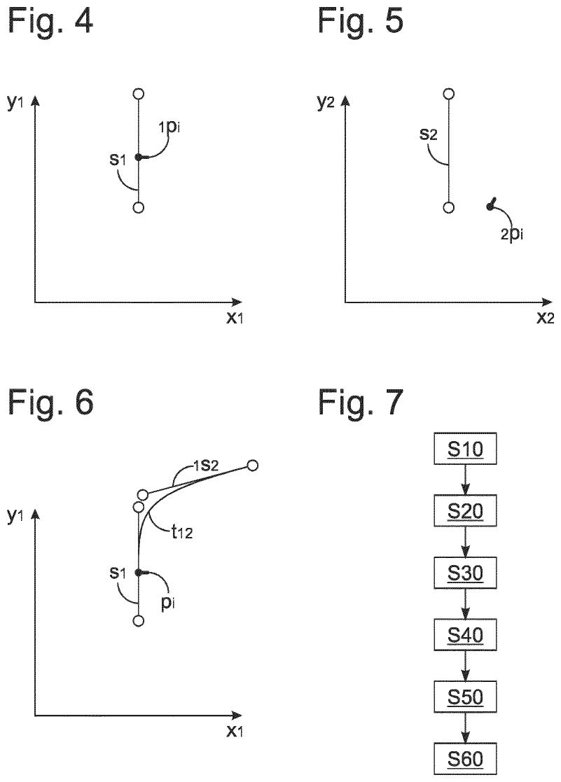

FIG. 1 shows an AGV 3 and a first, environment-related reference system, indicated by x₁, y₁, in which the AGV 3 is first navigated and in which a first path segment s₁ having an end pose p_{s1, e} (indicated by the filled circle with orientation bar) is specified.

In a second reference system, which is represented by in FIG. 2 by x₂, y₂, a second path segment s₂ having an initial pose p_{s2, a} and an end pose p_{s2, e} is specified, which the AGV 3 is intended to approach. This second reference system can in particular be an object-related or different environment-related reference system, in particular adjoining or overlapping, at least in part, with the reference system x₁, y₁.

In a first step S10 (cf. FIG. 7), the second path segment s₂ is transformed into the first reference system x₁, y₁, which is used as the common reference system. As a result, all, possibly only implicitly specified, poses of the second path segment s₂ are also (implicitly) transformed into the first reference system x₁, y₁.

In this case, this transformation into the common reference system is determined on the basis of an identity of the end pose p_{s1, e} on the first path segment s₁ to the initial pose p_{s2, a} on the second path segment s₂. In other words, the second reference system or path segment is transformed into the common or first reference system in such a way that, herein, the initial pose p_{s2, a} is identical to the end pose p_{s1, e}. In this way, the second reference system does not yet have to be initialized or calibrated at this time, in particular by a (second) localizer. Instead of the initial pose p_{s2, a}, a different pose relative to the second path can also be used, in particular a pose in which the reference system is initialized or calibrated.

Then, in a step S20, an initial transition path t₁₂ from the first path segment s₁ to the second path segment s₂ is planned in this common reference system on the basis of the now two path segments s₁, ₁s₂ described in said common reference system (cf. FIG. 3), which transitions in a continuously differentiable manner from the first to the second path segment.

Now the AGV 3 can start, in a step S30, to set off on the first path segment s₁. The second reference system is now initialized.

In a step S40, in an analogous manner the second path segment s₂ is transformed into the first reference system x₁, y₁.

In this case, this transformation into the common reference system is now determined on the basis of an identity of the actual pose ₂pᵢ of the robot in the second reference system x₂, y₂ with the actual pose ₁pᵢ of the robot in the common or first reference system x₁, y₁. In other words, the second reference system or path segment is transformed into the common or first reference system in such a way that the actual poses ₁pᵢ, ₂pᵢ are identical herein.

Then, in a step S50, the transition path t₁₂ is updated (cf. FIG. 6).

In a step S60, the AOV 3 travels further on the planned path, it being possible for the steps S40, S50 to be repeated one or more times. As soon as it reaches the transition path in this case, this can be kept constant and, if necessary, switched to the second reference system for navigating, without the AGV 3 having to stop in the process.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

p_{s1, e} End pose of the first path segment
p_{s2, a} Initial pose of the second path segment
p_{s2, e} End pose of the second path segment
₁pᵢ Actual pose, described in the first reference system
₂pᵢ Actual pose, described in the second reference system
s₁ First path segment
s₂ Second path segment, described in the second reference system
₁s₂ Second path segment, described in the first reference system
t₁₂ Transition path
x₁, y₁ First reference system
x₂, y₂ Second reference system
3 AGV (Robot)

What is claimed is:

1-13. (canceled)

14. A method for planning a path of a driverless mobile robot for approaching a second pose specified in a second reference system, from a first pose specified in a first reference system, the method comprising:
transforming with a computer one of the first or second pose into a common reference system, in which common reference system the other of the first or second pose is also described; and
planning a transition path from the first pose to the second pose in the common reference system on the basis of the first and second pose described in the common reference system.

15. The method of claim 14, wherein:
the first pose is specified on or by a first path segment in the first reference system; and
planning the transition path comprises planning based on the first path segment described in the common reference system.

16. The method of claim 15, wherein planning the transition path based on the first path segment comprises transforming the first path segment into the common reference system.

17. The method of claim 14, wherein:
the second pose is specified in the second reference system on or by a second path segment; and
planning the transition path comprises planning based on the second path segment described in the common reference system.

18. The method of claim 17, wherein planning the transition path based on the second path segment comprises transforming the second path segment into the common reference system.

19. The method of claim 14, wherein at least one of:
the first pose is specified in the first reference system on or by a first path segment, and transforming the first pose into the common reference system comprises transforming the first path segment into the common reference system; or
the second pose is specified in the second reference system on or by a second path segment, and transforming the second pose into the common reference system comprises transforming the second path segment into the common reference system.

20. The method of claim 14, wherein:
at least one of:
the first pose is specified in the first reference system by a first path segment, or
the second pose is specified in the second reference system by a second path segment; and
the method further comprises that the transition path continuously transfers from the first path segment to the second path segment.

21. The method of claim 14, wherein in that the common reference system is one of the first reference system or the second reference system.

22. The method of claim 19, wherein:
transforming of one of the first or second path segments into the common reference system is determined on the basis of a specified relation of a pose on the first path segment with a pose relative to the second path segment.

23. The method of claim 22, wherein at least one of:
the specified relation is an identity of the pose;
the pose on the first path segment is an end pose;
the pose on the second path segment is an initial pose; or
the relation of the pose relative to the second path segment is that the pose is on the second path segment.

24. The method of claim 14, wherein:
transforming of one of the first pose or the second pose into the common reference system is determined on the basis of a specified relation of a pose of the robot described in the reference system in which the one of the first and second pose is specified, with a pose of the robot described in the common reference system.

25. The method of claim 24, wherein at least one of:
the first pose is specified in the first reference system by a first path segment, and transforming the first pose into the common reference system comprises transforming the first path segment into the common reference system;
the second pose is specified in the second reference system by a second path segment, and transforming the second pose into the common reference system comprises transforming the second path segment into the common reference system;
the specified relation is an identity; or
the pose of the robot described in the reference system or in the common reference system is an actual pose of the robot.

26. The method according to claim 14, wherein:
the first reference system is an environment-related reference system; and
the second reference system is one of an object-related reference system or a different environment-related reference system.

27. The method of claim 26, wherein the second reference system adjoins the first reference system or overlaps therewith at least in part.

28. A method for operating a driverless mobile robot, comprising:
planning a path for approaching a second pose from a first pose according to claim 14; and
travelling the path with the robot, in particular using at least one of the first reference system, the second reference system, or the common reference system.

29. The method of claim 28, further comprising at least one of:
updating the transition path; or
updating the transformation into the common reference system.

30. The method of claim 29, wherein updating comprises updating while travelling the path with the robot.

31. A system for planning a path of a driverless mobile robot for approaching a second pose specified in a second reference system, from a first pose specified in a first reference system, the system comprising:
means for transforming one of the first or second pose into a common reference system, in which common reference system the other of the first or second pose is also described; and
means for planning a transition path from the first pose to the second pose in the common reference system on the basis of the first and second pose described in the common reference system.

32. The system of claim 31, further comprising:
means for travelling the path using the robot, in particular using at least one of the first reference system, the second reference system, or the common reference system.

33. A computer program product for planning a path of a driverless mobile robot for approaching a second pose specified in a second reference system, from a first pose specified in a first reference system, the computer program product comprising program code stored on a non-transitory, computer-readable medium, the program code, when executed on a computer, causing the computer to:
transform one of the first or second pose into a common reference system, in which common reference system the other of the first or second pose is also described, and
plan a transition path from the first pose to the second pose in the common reference system on the basis of the first and second pose described in the common reference system.
